(19) United States
(12) Patent Application Publication
(10) Pub. No.: US 2022/0070729 A1
(43) Pub. Date: Mar. 3, 2022

(54) TRANSMITTING APPARATUS AND RECEIVING APPARATUS

(71) Applicants: SHARP KABUSHIKI KAISHA, Sakai City, Osaka (JP); FG Innovation Company Limited, Tuen Mun, New Territories (HK)

(72) Inventors: SEIJI SATO, Sakai City, Osaka (JP); YASUHIRO HAMAGUCHI, Sakai City, Osaka (JP)

(73) Assignees: SHARP KABUSHIKI KAISHA, Sakai City, Osaka (JP); FG Innovation Company Limited, Tuen Mun, New Territories (HK); FG Innovation Company Limited, Tuen Mun, New Territories (HK)

(21) Appl. No.: 17/420,896

(22) PCT Filed: Jan. 10, 2020
(86) PCT No.: PCT/JP2020/000737

§ 371 Date: Jul. 6, 2021

(30) Foreign Application Priority Data
Jan. 11, 2019 (JP) 2019-003329

(51) Int. Cl. H04W 28/06; H04L 29/06

(52) U.S. Cl. CPC H04W 28/06; H04L 69/22

(57) ABSTRACT

A transmitting apparatus includes: multiple transmission data compression and coding units configured to perform, based on one or multiple pieces of header compression and coding configuration information of transmission data included in a higher layer message, compression and coding of the transmission data. First header compression and coding configuration information includes first compression and coding profile configuration for a first communication protocol header. Second header compression and coding configuration information includes second compression and coding profile configuration for a second communication protocol header. A first transmission data compression and coding unit compresses and codes the first communication protocol header included in the transmission data, based on the first header compression and coding configuration information. A second transmission data compression and coding unit compresses and codes the second communication protocol header included in the transmission data, based on the second header compression and coding configuration information.

### TECHNICAL FIELD

The present invention relates to a transmitting apparatus, a receiving apparatus, and a communication method thereof. This application claims priority based on JP 2019-3329 filed on Jan. 11, 2019, the contents of which are incorporated herein by reference.

### BACKGROUND ART

In the standardization organization, 3rd Generation Partnership Project (3GPP), specifications of Evolved Universal Terrestrial Radio Access (also referred to as “EUTRA” or “LTE”), which has been developed by evolving the third-generation mobile communication scheme and Advanced EUTRA (also referred to as “LTE-Advanced” or “LTE-A”), which is a fourth generation mobile communication scheme and has been developed by further evolving EUTRA, have been standardized, and mobile communications using such specifications are commercialized in different countries (NPL 1). Further, in recent years, in 3GPP, technical study and specification standardization of New Radio (NR), which is a fifth generation mobile communication scheme, have been carried out (NPL 2). In the fifth generation mobile communication scheme, technologies such as enhanced Mobile BroadBand (eMBB; high speed and large capacity), Ultra-Reliable and Low Latency Communicaion (URLLC; ultra-high reliability and low latency), and massive Machine Type Communicaion (mMTC; multiple terminal access) are adopted, and implementation of the Internet of Things (IoT) have been intended. Further, study of applying a radio network of the fifth generation mobile communication scheme to the industrial IoT (IIoT; Industory IoT) has also been carried out (NPL 3).

### CITATION LIST

### Non Patent Literature

NPL 1: “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 15)” 3GPP TS 36.300 V15.3.0 (2018-09)
NPL 2: “3rd Generation Partnership Project; Technical Specification Group Radio Access Network; NR; NR and NG-RAN Overall Description; Stage 2 (Release 15)” 3GPP TS 38.300 V15.3.0 (2018-09)
NPL 3: “3GPP TSG-RAN meeting #81; RP-182090; Title: Study on NR Industrial Internet of Things (IoT)”

### SUMMARY OF INVENTION

### Technical Problem

In the IIoT, high speed real time transmission processing of high frequency transmission data from a large number of terminals is required, and thus information amount reduction of individual pieces of transmission data is required.

An aspect of the present invention is made in the light of the circumstances as described above, and has an object to provide a transmitting apparatus and a receiving apparatus that reduce information having high redundancy included in transmission data by compression and coding to thereby implement high speed real time transmission processing of high frequency transmission data from a large number of terminals.

### Solution to Problem

(1) The present invention is made in order to solve the problem described above, and is a transmitting apparatus of a communication system at least including a transmitting apparatus and a receiving apparatus according to an aspect of the present invention, the transmitting apparatus including: multiple transmission data compression and coding units configured to perform, based on one or multiple pieces of header compression and coding configuration information of transmission data included in a higher layer message, compression and coding of the transmission data, wherein first header compression and coding configuration information includes first compression and coding profile configuration for a first communication protocol header, second header compression and coding configuration information includes second compression and coding profile configuration for a second communication protocol header, a first transmission data compression and coding unit compresses and codes the first communication protocol header included in the transmission data, based on the first header compression and coding configuration information, and a second transmission data compression and coding unit compresses and codes the second communication protocol header included in the transmission data, based on the second header compression and coding configuration information.

(2) The transmitting apparatus according to an aspect of the present invention is the transmitting apparatus described above, wherein the first communication protocol header compressed and coded in the first transmission data compression and coding unit is a header for Ethernet (trade name) and a protocol associated with Ethernet (trade name), and the second communication protocol header compressed and coded in the second transmission data compression and coding unit is a communication protocol other than the first communication protocol header.

(3) The transmitting apparatus according to an aspect of the present invention is the transmitting apparatus described above, wherein the first header compression and coding configuration information and the second header compression and coding configuration information are applicable only to an uplink.

(4) The transmitting apparatus according to an aspect of the present invention is the transmitting apparatus described above, wherein the first header compression and coding configuration information and the second header compression and coding configuration information are applicable only to a downlink.

(5) A receiving apparatus according to an aspect of the present invention is a receiving apparatus of a communication system at least including a transmitting apparatus and a receiving apparatus, the receiving apparatus including: multiple received data decoding and decompression units configured to perform, based on one or multiple pieces of header compression and coding configuration information of received data included in a higher layer message, compression and coding of the received data, wherein first header compression and coding configuration information includes first compression and coding profile configuration for a first communication protocol header, second header compression and coding configuration information includes second compression and coding profile configuration for a second communication protocol header, a first received data decoding and decompression unit reconstructs the first communication protocol header by decoding and decompressing the received data, based on the first header compression and coding configuration information, and a second received data decoding and decompression unit reconstructs the second communication protocol header by decoding and decompressing the received data, based on the second header compression and coding configuration information.

(6) The receiving apparatus according to an aspect of the present invention is the receiving apparatus described above, wherein the first communication protocol header reconstructed through decoding and decompression in the first received data decoding and decompression unit is a header for Ethernet (trade name) and a protocol associated with Ethernet (trade name), and the second communication protocol header decoded and decompressed in the second received data decoding and decompression unit is a communication protocol other than the first communication protocol header.

(7) The receiving apparatus according to an aspect of the present invention is the receiving apparatus described above, wherein the first header compression and coding configuration information and the second header compression and coding configuration information are applicable only to an uplink.

(8) The receiving apparatus according to an aspect of the present invention is the receiving apparatus described above, wherein the first header compression and coding configuration information and the second header compression and coding configuration information are applicable only to a downlink.

(9) A transmitting apparatus according to an aspect of the present invention is a transmitting apparatus of a communication system at least including a transmitting apparatus and a receiving apparatus, the transmitting apparatus including: multiple transmission data compression and coding units configured to perform, based on one or multiple pieces of header compression and coding configuration information of transmission data included in a higher layer message, compression and coding of the transmission data; and a feedback reception unit configured to receive a feedback PDU from the receiving apparatus, wherein the feedback PDU includes first feedback data for a first transmission data compression and coding unit and second feedback data for a second transmission data compression and coding unit, and the feedback reception unit separates the first feedback data and the second feedback data from the feedback PDU, transmits the first feedback data to the first transmission data compression and coding unit, and transmits the second feedback data to the second transmission data compression and coding unit.

(10) A receiving apparatus according to an aspect of the present invention is a receiving apparatus of a communication system at least including a transmitting apparatus and a receiving apparatus, the receiving apparatus including: multiple received data decoding and decompression units configured to perform, based on one or multiple pieces of header compression and coding configuration information of received data included in a higher layer message, compression and coding of the received data: and a feedback transmission unit configured to transmit a feedback PDU to the transmitting apparatus, wherein the feedback PDU includes first feedback data from a first received data decoding and decompression unit and second feedback data from a first received data decoding and decompression unit, and the feedback transmission unit generates a feedback PDU including the first feedback data and the second feedback data, and transmits the feedback PDU to the transmitting apparatus.

### Advantageous Effects of Invention

According to an aspect of the invention, a transmitting apparatus and a receiving apparatus that reduce information having high redundancy included in transmission data by compression and coding to thereby implement high speed real time transmission processing of high frequency transmission data from a large number of terminals can be provided.

### BRIEF DESCRIPTION OF DRAWINGS

FIG. 1 is a diagram illustrating an example of a case that a transmitting apparatus and a receiving apparatus according to an aspect of the present invention are caused to communicate with each other while being incorporated into a terminal apparatus and a base station apparatus.

FIG. 2 is a diagram illustrating an example of a configuration of the transmitting apparatus according to an aspect of the present invention.

FIG. 3 is a diagram illustrating an example of a configuration of the receiving apparatus according to an aspect of the present invention.

FIG. 4 is a diagram illustrating a part of a header compression and coding profile defined in ROHC.

FIG. 5 illustrates an example of a structure of header compression and coding configuration information included in a message from a higher layer according to a first embodiment of the present invention.

FIG. 6 is a diagram illustrating an example of available profile lists included in first header compression and coding configuration information and second header compression and coding configuration information according to the first embodiment of the present invention.

FIG. 7 is a diagram illustrating an example of operation of compression and coding and decoding and decompression of data performed by the transmitting apparatus and the receiving apparatus according to an aspect of the present invention.

FIG. 8 is a diagram illustrating an example of operation of compression and coding and decoding and decompression of data performed by the transmitting apparatus and the receiving apparatus according to an aspect of the present invention.

FIG. 9 is a diagram illustrating an example of operation of compression and coding and decoding and decompression of data performed by the transmitting apparatus and the receiving apparatus according to an aspect of the present invention.

FIG. 10 is a diagram illustrating an example of a relationship between a value of a type of a feedback PDU and a data type of a case that an aspect of the present invention is applied.

FIG. 11 is a diagram illustrating an example of a format of a feedback PDU according to the first embodiment of the present invention.

FIG. 12 illustrates an example of a structure of header compression and coding configuration information included in a message from a higher layer according to a second embodiment of the present invention.

FIG. 13 illustrates an example of an available profile list according to the second embodiment of the present invention.

FIG. 14 is a diagram illustrating an example of a format of a feedback PDU according to the second embodiment of the present invention.

### DESCRIPTION OF EMBODIMENTS

### First Embodiment

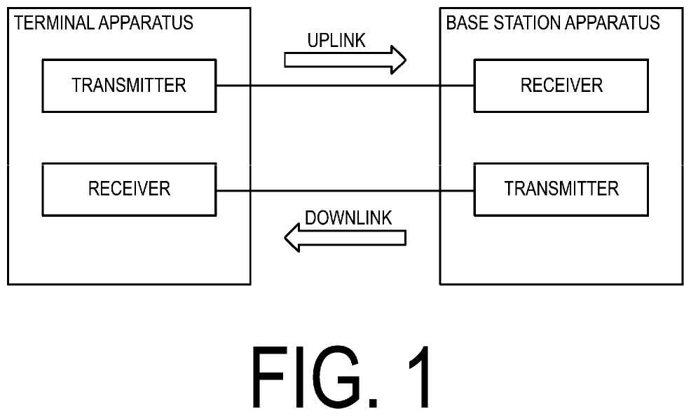

A first embodiment of the present invention will be described below with reference to the drawings. FIG. 1 illustrates an example of a case that a transmitting apparatus and a receiving apparatus according to an aspect of the present invention are caused to communicate with each other while being incorporated into a terminal apparatus and a base station apparatus. As illustrated in FIG. 1, uplink data is transmitted from the transmitting apparatus of the terminal apparatus to the receiving apparatus of the base station apparatus, and downlink data is transmitted from the transmitting apparatus of the base station apparatus to the receiving apparatus of the terminal apparatus.

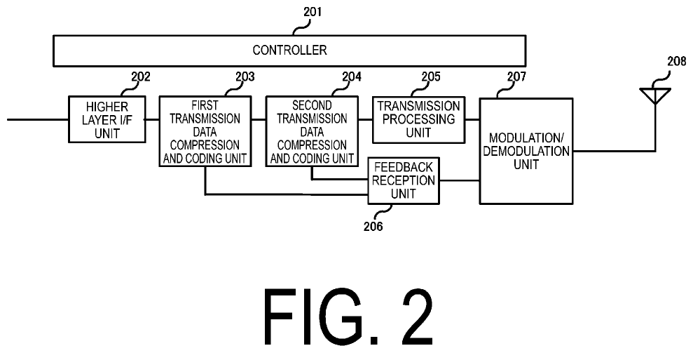

FIG. 2 illustrates an example of a configuration of the transmitting apparatus in a case that the present invention is applied. In FIG. 2, 201 denotes a controller that controls the overall transmitting apparatus. 202 denotes a higher layer interface (I/F) unit that performs delivery of data with a higher layer. 203 denotes a first transmission data compression and coding unit, and 204 denotes a second transmission data compression unit, and each performs compression and coding of the header of transmission data or the entire transmission data. 205 denotes a transmission processing unit, and performs split processing and error correction coding processing on transmission data, and processing such as allocation of transmission resources and retransmission. 206 receives feedback data from the receiving apparatus, and performs feedback to the first transmission data compression and coding unit 203 and the second transmission data compression and coding unit 204. 207 denotes a modulation/demodulation unit, and performs modulation/demodulation for transmitting and/or receiving data through an antenna unit 208 on a radio signal. 208 denotes an antenna unit, and performs transmission and/or reception of a radio signal to and/or from the receiving apparatus.

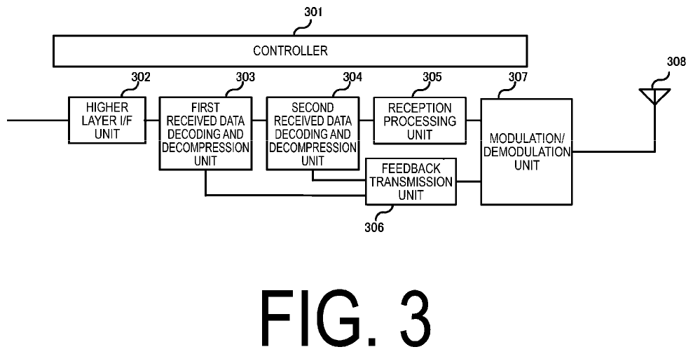

FIG. 3 illustrates an example of a configuration of the receiving apparatus in a case that the present invention is applied. In FIG. 3, 301 denotes a controller that controls the overall receiving apparatus. 302 denotes a higher layer interface (I/F) unit that performs delivery of data with a higher layer. 303 denotes a first received data decoding and decompression unit, and 304 denotes a second received data decoding and decompression unit, which decode and decompress received data that has been compressed and coded, and reconstruct the header or the entire received data. 305 denotes a reception processing unit, and performs concatenation processing and error correction processing on the received data, retransmission request processing for the transmitting apparatus, and the like. 306 denotes a feedback transmission unit, and performs processing for transmitting the feedback data from the first received data decoding and decompression unit 303 and the second received data decoding and decompression unit 304 to the transmitting apparatus. 307 denotes a modulation/demodulation unit, and performs modulation/demodulation for transmitting and/or receiving data through an antenna unit 308 on radio. 308 denotes an antenna unit, and performs transmission and/or reception of a radio signal to and/or from the transmitting apparatus.

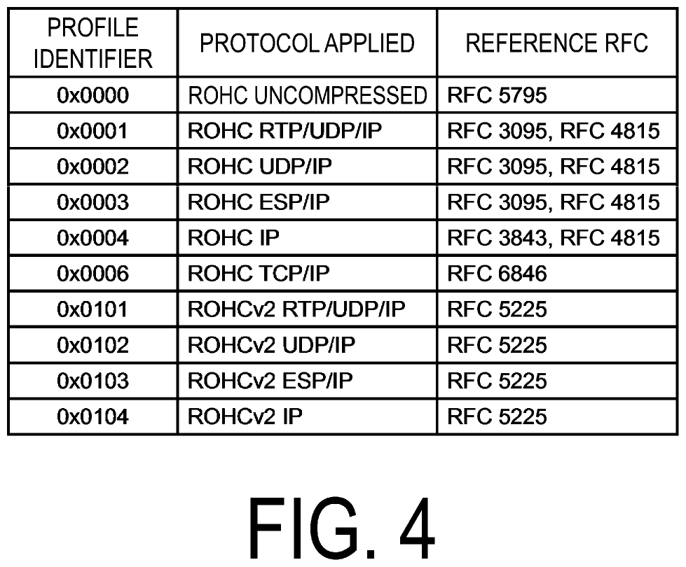

As an example of a compression and coding scheme used in the transmission data compression and coding unit 203 and the received data decoding and decompression unit 303, there is Robust Header Compression (ROHC). In ROHC, data itself (payload) is not compressed and coded, but compression and coding is performed on header information that is added to the payload by the communication protocol used for transmission and/or reception. ROHC is effective for information amount reduction of data having a size of the payload being relatively small and high transmission and/or reception frequencies. In ROHC, an optimal compression and coding scheme is defined as a profile in advance depending on a combination of protocols being used, and a profile for a combination of the protocols such as the IP, the TCP, the UDP, and the RTP (hereinafter referred to as an IP system protocol) is defined by a Request For Comments (RFC) of the Internet Engineering Task Force (IETF). FIG. 4 is an example of the profile of ROHC defined in the RFC. In contrast, the profile of ROHC for the communication protocol (hereinafter referred to as a non-IP system protocol) that does not use the IP system protocol, such as Ethernet (trade name) and EtherCAT (trade name) transmitted on Ethernet (trade name), and a combination of those protocols has not yet been defined in the RFC of the IETF; however, by applying ROHC to these as well, the information amount can be efficiently reduced. However, this requires new definition of the profile of ROHC for Ethernet (trade name) and the non-IP system protocol, an also requires new definition of the profile of ROHC for the combination of Ethernet (trade name) and the IP system protocol, and thus there is a fear that the total number of profiles may be massive. In view of this, this problem is to be solved by causing ROHC for Ethernet (trade name) and non-IP system protocol to operate in parallel to ROHC for the IP system protocol.

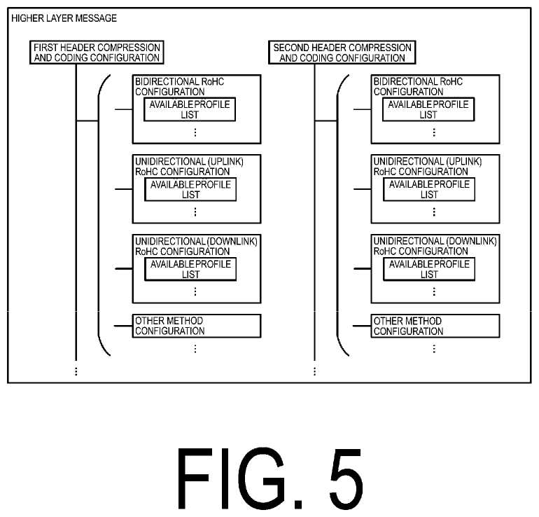

FIG. 5 illustrates an example of a structure of header compression and coding configuration information included in a message from a higher layer according to the present embodiment. In the message from a higher layer, first header compression and coding configuration information and second header compression and coding configuration information are included. In each of the first header compression and coding configuration information and the second header compression and coding configuration information, only one piece of configuration information of the compression and coding scheme to be used is included. Specifically, in a case of using bidirectional ROHC, only bidirectional ROHC configuration information is included, in a case of using only uplink unidirectional ROHC, only unidirectional (uplink) ROHC configuration information is included, and in a case of using only downlink unidirectional ROHC, only unidirectional (downlink) ROHC configuration information is included. Note that, also in a case of using a configuration of a compression and coding scheme other than these, similarly, only the configuration information of the compression and coding scheme is included. Note that each of the bidirectional ROHC configuration information, the unidirectional (uplink) ROHC configuration information, and the unidirectional (downlink) ROHC configuration information includes an available profile list, in which combinations of a profile identifier and availability information of the profile corresponding to the profile identifier are listed up for each profile. In addition to the above, information such as a necessary configuration and a parameter may be included for each compression and coding scheme. Note that, in a case that no configuration information of the compression and coding scheme to be used is included in the first header compression and coding configuration information or the second header compression and coding configuration information, the header compression and coding and decoding and decompression are not performed. For example, in a case that the unidirectional (uplink) ROHC configuration is included in the first header compression and coding configuration information, in a case of the terminal apparatus, first header compression and coding of the transmitting apparatus operates; however, decoding and decompression of first header compression and coding of the receiving apparatus does not operate. Similarly, in a case of the base station apparatus, decoding and decompression of first header compression and coding of the receiving apparatus operates; however, first header compression and coding of the transmitting apparatus does not operate. In a case that the unidirectional (downlink) ROHC configuration is included in the first header compression and coding configuration information, in a case of the terminal apparatus, decoding and decompression of first header compression and coding of the receiving apparatus operates; however, first header compression and coding of the transmitting apparatus does not operate. Similarly, in a case of the base station apparatus, first header compression and coding of the transmitting apparatus operates; however, decoding and decompression of first header compression and coding of the receiving apparatus does not operate. Also, in a case that the unidirectional (uplink) ROHC configuration or the unidirectional (downlink) ROHC configuration is included in the second header compression and coding configuration information, similar operation as described above is performed for both of the terminal apparatus and the base station apparatus.

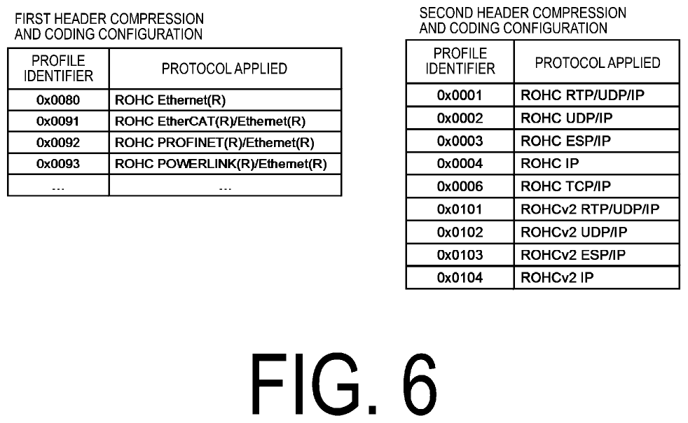

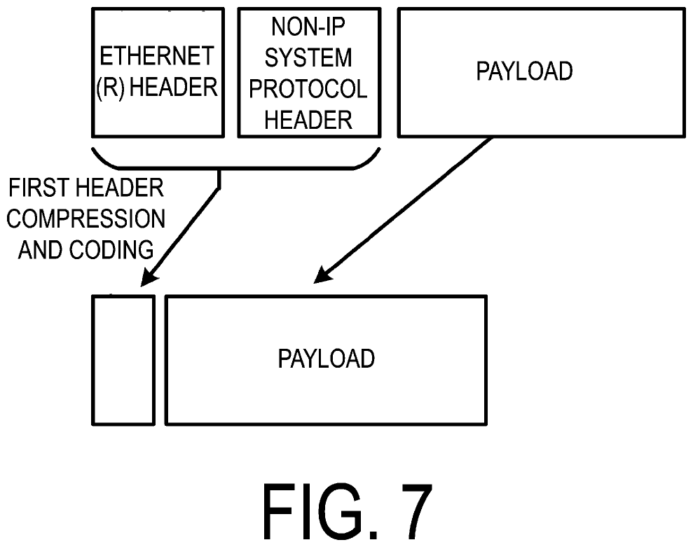

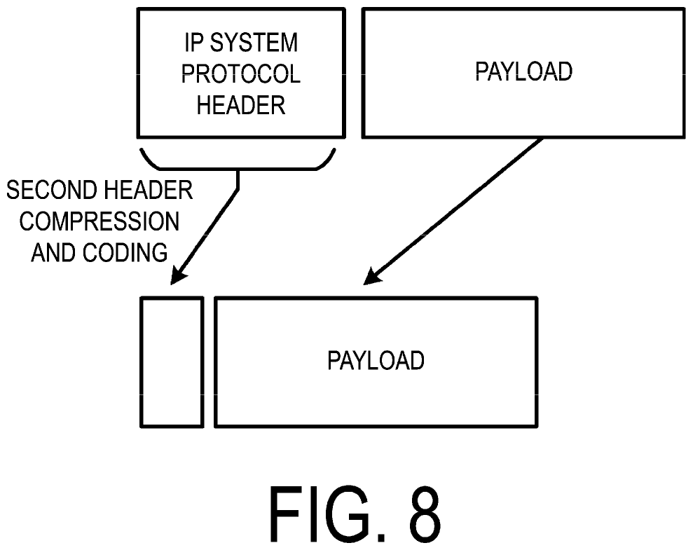

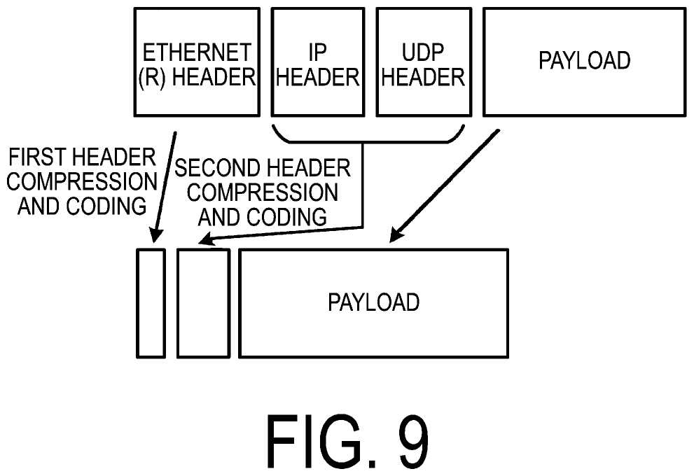

As an example, as illustrated in FIG. 6, the bidirectional ROHC configuration including the available profile list for the combination of the non-IP system protocols such as Ethernet (trade name), EtherCAT (trade name), and PROFINET (trade name) is incorporated in the first header compression and coding configuration information, and the bidirectional ROHC configuration including the available profile list for the combination of the IP system protocols (the IP, the UDP, the RTP, the ESP, and the like) is incorporated in the second header compression and coding configuration information. With this configuration, the controller 201 of the transmitting apparatus configures the first transmission data compression and coding unit 203 to perform application of the first header compression and coding configuration, specifically, header compression and coding of Ethernet (trade name) and the non-IP system protocol, and configures the second transmission data compression and coding unit 204 to perform application of the second header compression and coding configuration, specifically, header compression and coding of the IP system protocol. The controller 301 of the receiving apparatus configures the first received data decoding and decompression unit 303 to perform application of the first header compression and coding configuration information, specifically, header decoding and decompression of Ethernet (trade name) and the non-IP system protocol, and configures the second received data decoding and decompression unit 304 to perform application of the second header compression and coding configuration information, specifically, header decoding and decompression of the IP system protocol. In this case, for the data of Ethernet (trade name) and the non-IP system protocol as illustrated in the upper part of FIG. 7, the transmitting apparatus performs header compression and coding according to the first header compression and coding configuration information in the first transmission data compression and coding unit 203, and transmits the data. Note that the second transmission data compression and coding unit 204 does not perform anything. In a case that the receiving apparatus receives data after the header compression and coding as illustrated in the lower part of FIG. 7, the receiving apparatus performs decoding and decompression of the header according to the first header compression and coding configuration information in the first received data decoding and decompression unit 303, and reconstructs the data to the data in the upper part of FIG. 7. Note that the second received data decoding and decompression unit 304 does not perform anything. For the transmission data of the IP system protocol as illustrated in the upper part of FIG. 8, the transmitting apparatus performs header compression and coding according to the second header compression and coding configuration information in the second transmission data compression and coding unit 204, and transmits the transmission data. Note that the first transmission data compression and coding unit 203 does not perform anything. In a case that the receiving apparatus receives data after the header compression and coding as illustrated in the lower part of FIG. 8, the second received data decoding and decompression unit 304 performs decoding and decompression of the header according to the second header compression and coding configuration information, and reconstructs the data to the data of the upper part of FIG. 8. Note that the first received data decoding and decompression unit 303 does not perform anything. In a case of transmission data of Ethernet (trade name) and the IP system protocol as illustrated in the upper part of FIG. 9, the transmitting apparatus performs header compression and coding according to the first header compression and coding configuration information in the first transmission data compression and coding unit 203 for the header of Ethernet (trade name), and performs header compression and coding according to the second header compression and coding configuration information in the second transmission data compression and coding unit 204 for the header of the IP system protocol and transmits the transmission data. In a case that the receiving apparatus receives data after the header compression and coding as illustrated in the lower part of FIG. 9, the receiving apparatus performs decoding and decompression of the header according to the first header compression and coding configuration information in the first received data decoding and decompression unit 303 for the compression and coding data of the Ethernet (trade name) header part, and the second received data decoding and decompression unit 304 further performs decoding and decompression of the compression and coding data of the header part of the IP system protocol according to the second header compression and coding configuration information, and reconstructs the data to the data in the upper part of FIG. 9.

Note that, in ROHC, compression and coding is performed by using time-series correlation of a header, and thus in a case that there is an error in decoding and decompression of compression and coding data in the receiving apparatus or the like, decoding and decompression of subsequent data may not be able to be performed. As a countermeasure for this, by transmitting decoding and decompression results of data after compression and coding from the transmitting apparatus and the like from the receiving apparatus to the transmitting apparatus as feedback data, temporal propagation of the decoding and decompression error can be prevented.

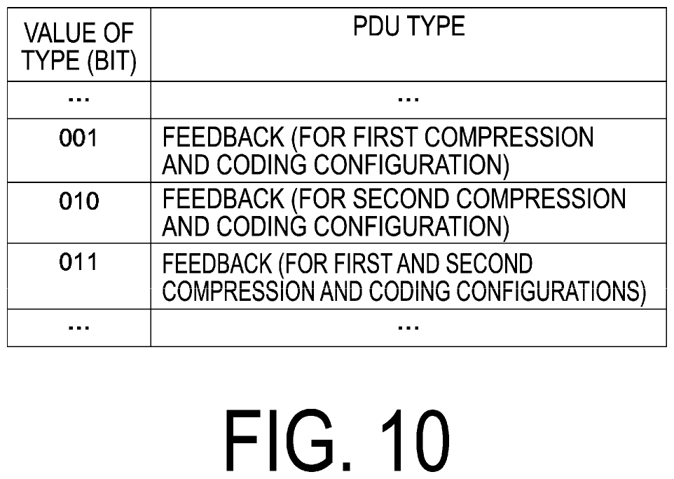

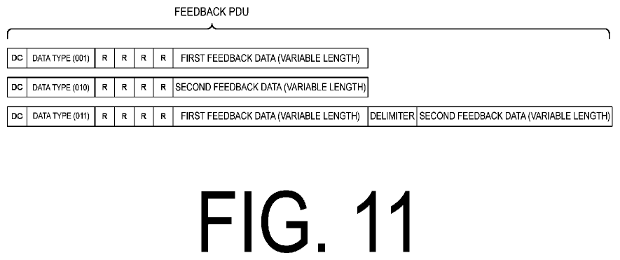

In the present embodiment, two different header compression and coding configurations are caused to independently operate in each of the two transmission data compression and coding units 203 and 204 of the transmitting apparatus and the two received data decoding and decompression units 303 and 304 of the receiving apparatus, and thus each piece of feedback data needs to be transmitted and/or received. A method for this will be described below. FIG. 10 illustrates an example of a relationship between a value of a type of a feedback PDU for transmitting the feedback data and a PDU type, and the feedback reception unit 305 identifies the PDU type of the received feedback PDU by using the value of the type. FIG. 11 illustrates an example of a format for each type of the feedback PDU. Here, DC represents whether data is control data or user data, and in a case of the feedback PDU, 1 representing the control data is configured. 0 is invariably configured for R. In a case that the type of the feedback PDU is 001, specifically, in a case of the feedback for the first compression and coding configuration, the first feedback data with a variable length is configured for the data part. The first feedback data is delivered from the feedback reception unit 206 to the first transmission data compression and coding unit 203 of the transmitting apparatus. In a case that the type of the feedback PDU is 010, specifically, in a case of the feedback for the second compression and coding configuration, the second feedback data with a variable length is configured for the data part. The second feedback data is delivered from the feedback reception unit 206 to the second transmission data compression and coding unit 204 of the transmitting apparatus. In a case that the type of the feedback PDU is 011, specifically, in a case of the feedback for the first and second compression and coding configurations, both of the first feedback data and the second feedback data are configured for the data part. Here, each piece of feedback data has a variable length, and thus a delimiter is inserted between the first feedback data and the second feedback data. For the delimiter, a unique value (0000, FFFF, AAAA, 8888, F0F0, and the like in hexadecimal numbers) is determined in advance, so that a boundary between the two pieces of feedback data is known. The feedback reception unit 206 of the transmitting apparatus separates the first feedback data and the second feedback data by using the delimiter, and delivers the first feedback data to the first transmission data compression and coding unit 203 and the second feedback data to the second transmission data compression and coding unit 204, respectively. Note that the value of the type of the feedback PDU and the value of the delimiter are not limited to those described above, and other values may be used.

Note that the above description illustrates an example using ROHC as the data compression and coding scheme. However, a data compression and coding scheme other than ROHC may be used. For example, the entire transmission data including the header may be compressed and coded with algorithm such as DEFLATE, as with the case in Uplink Data Compression (UDC) defined in LTE and LTE-A. Application is also possible to other protocols, not only to the protocols illustrated in FIG. 4 and FIG. 6. The values of the profile identifiers for the non-IP system protocol illustrated in FIG. 6 are also not limited to those, and other values can also be used in so far as the values do not overlap with other profiles.

As described above, according to the first embodiment of the present invention, compression and coding can also be efficiently performed on the transmission data including Ethernet (trade name) and the non-IP system protocol.

### Second Embodiment

The first embodiment describes an example in which a higher layer message includes two header compression and coding configurations, and the available profile list is included in each of the two header compression and coding configurations. However, there is a method in which two header compression and coding configurations are indicated with one profile identifier. This will be described as a second embodiment.

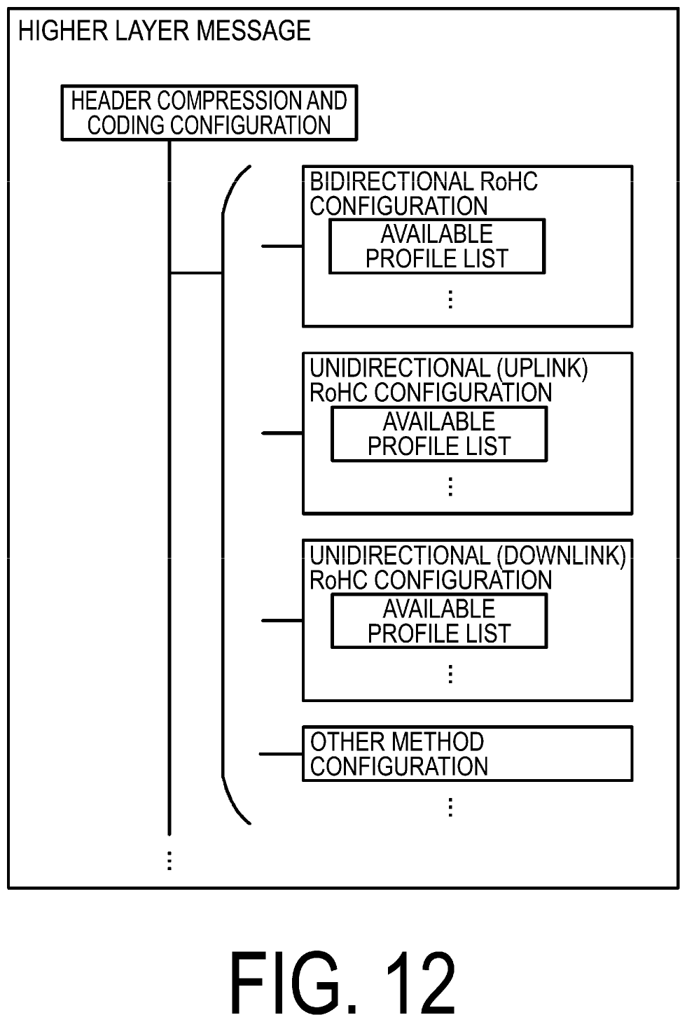

FIG. 12 illustrates a structure of header compression and coding configuration information from a higher layer according to the present embodiment. In a message from a higher layer, one piece of header compression and coding configuration information is included. In the header compression and coding configuration information, only one piece of configuration information of the compression and coding scheme to be used is included. Specifically, in a case of using the bidirectional ROHC, only the bidirectional ROHC configuration information is included, in a case of using only the uplink unidirectional ROHC, only the unidirectional (uplink) ROHC configuration information is included, and in a case of using only the downlink unidirectional ROHC, only the unidirectional (downlink) ROHC configuration information is included. Note that, also in a case of using a configuration of a compression and coding scheme other than these, similarly, only the configuration information of the compression and coding scheme is included. Note that each of the bidirectional ROHC configuration information, the unidirectional (uplink) ROHC configuration information, and the unidirectional (downlink) ROHC configuration information includes an available profile list, in which combinations of a profile identifier and availability information of the profile corresponding to the profile identifier are listed up for each profile. In addition to the above, information such as a necessary configuration and a parameter may be included for each compression and coding scheme. Note that, in a case that no configuration information of the compression and coding scheme to be used is included in the header compression and coding configuration information, the header compression and coding and decoding and decompression are not performed. In a case that the unidirectional (uplink) ROHC configuration is included in the header compression and coding configuration information, in a case of the terminal apparatus, first header compression and coding and second header compression and coding of the transmitting apparatus operate; however, decoding and decompression of first header compression and coding and second header compression and coding of the receiving apparatus does not operate. Similarly, in a case of the base station apparatus, decoding and decompression of first header compression and coding and second compression and coding of the receiving apparatus operates; however, first header compression and coding and second header compression and coding of the transmitting apparatus do not operate. In a case that the unidirectional (downlink) ROHC configuration is included in the header compression and coding configuration information, in a case of the terminal apparatus, decoding and decompression of first header compression and coding and second header compression and coding of the receiving apparatus operates; however, first header compression and coding and second header compression and coding of the transmitting apparatus do not operate. Similarly, in a case of the base station apparatus, first header compression and coding and second header compression and coding of the transmitting apparatus operate; however, decoding and decompression of first header compression and coding and second header compression and coding of the receiving apparatus does not operate.

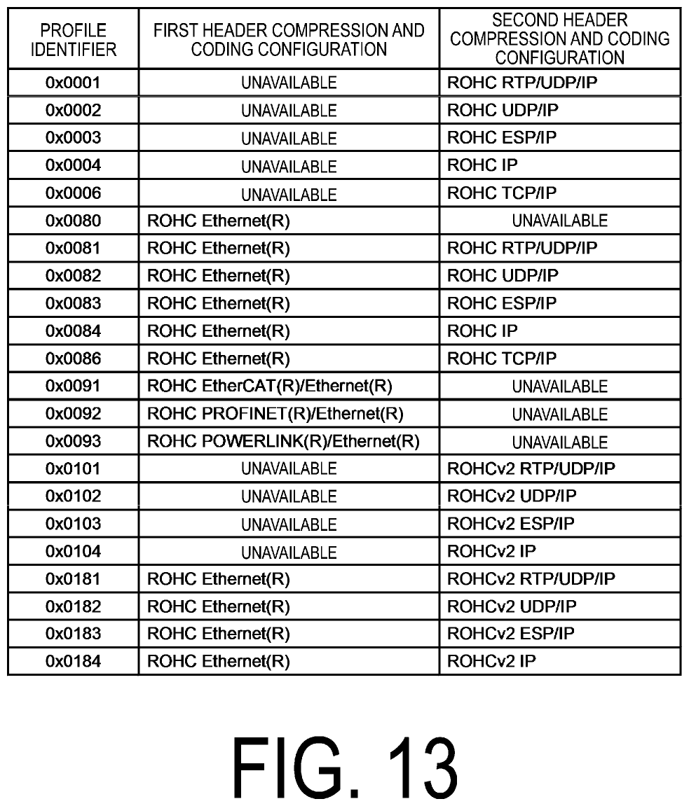

FIG. 13 illustrates a configuration that each of the first header compression and coding configuration and the second header compression and coding configuration is allocated to each profile identifier. For example, with a profile identifier 0x0080, the first header compression and coding configuration is ROHC Ethernet (trade name), and the second header compression and coding configuration is unavailable. With a profile identifier 0x0004, the first header compression and coding configuration is unavailable, and the second header compression and coding configuration is ROHC IP. With a profile identifier 0x0084, the first header compression and coding configuration is ROHC Ethernet (trade name), and the second header compression and coding configuration is ROHC IP. The controllers 201 and 301 configure, for the header compression and coding configuration included in a higher layer message, the first transmission data compression and coding unit 203 and the second transmission data compression and coding unit 204 of the transmitting apparatus and the first received data decoding and decompression unit 303 and the second received data decoding and decompression unit 304 of the receiving apparatus, according to the available profile list as illustrated in FIG. 13. Operation of header compression and coding and decoding and decompression for the data illustrated in FIG. 7, FIG. 8, and FIG. 9 is similar to that of the first embodiment, and description thereof is thus omitted.

Note that the above description illustrates an example using ROHC as the data compression and coding scheme. However, a data compression and coding scheme other than ROHC may be used. For example, the entire transmission data including the header may be compressed and coded with algorithm such as DEFLATE, as in Uplink Data Compression (UDC) defined in LTE and LTE-A. Application is also possible to other protocols, not only to the protocols illustrated in FIG. 13. The values of the profile identifiers for the non-IP system protocol illustrated in FIG. 10 are also not limited to those, and other values can also be used in so far as the values do not overlap with other profiles.

As described above, according to the second embodiment of the present invention, compression and coding can also be efficiently performed on the transmission data including Ethernet (trade name) and the non-IP system protocol.

### Third Embodiment

The first embodiment describes a method in which two pieces of feedback data with variable lengths are put together into one piece of feedback data to be transmitted and/or received by using a delimiter. However, there is a method of not using a delimiter. In the present embodiment, a method for this will be described below.

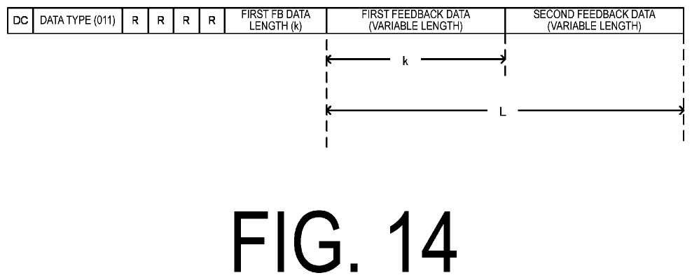

FIG. 14 illustrates a format of a case that first feedback data and second feedback data are transmitted, with information of a first feedback (FB) data length (represented by k) being added thereto. The feedback reception unit 206 uses a part having a length k from the beginning of data as the first feedback data, and the rest of the part as the second feedback data. Note that, in a case that k has the same value as the entire length L of the feedback PDU, the second feedback data is not included. In a case that k is 0, the first feedback data is not included. With this configuration, the feedback reception unit 206 can deliver the separated first feedback data and second feedback data to the first transmission data compression and coding unit and the second transmission data compression and coding unit, respectively.

As described above, according to the third embodiment of the present invention, two pieces of feedback data having different compression and coding schemes can be put together into one piece of feedback data to be transmitted and/or received, and this is thus efficient.

In addition, a program used for realizing all or some of the functions of the transmitting apparatus and the receiving apparatus described above may be recorded on a computer-readable recording medium, and the processing of each unit may be performed by causing a computer system to read and perform the program recorded on the recording medium. The “computer system” here includes an OS and hardware components such as a peripheral device.

Further, the “computer system” includes an environment for supplying a home page (or environment for display) in a case that a WWW system is utilized.

Furthermore, a “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium, such as a communication line that is used to transmit the program via a network such as the Internet or via a communication line such as a telephone line, that dynamically retains the program for a short period of time, and a medium, such as a volatile memory within the computer system which functions as a server or a client in that case, that retains the program for a fixed period of time. Furthermore, the above-described program may be one for realizing some of the above-described functions, and also may be one capable of realizing the above-described functions in combination with a program already recorded in a computer system.

Furthermore, all or some of the functions of the transmitting apparatus and the receiving apparatus may be realized by aggregating the functions into an integrated circuit. Each functional block may be individually realized as chips, or may be partially or completely integrated into a chip. Furthermore, a circuit integration technique is not limited to the LSI, and may be realized with a dedicated circuit or a general-purpose processor. Moreover, in a case that with advances in semiconductor technology, a circuit integration technology with which an LSI is replaced appears, it is also possible to use an integrated circuit based on the technology.

The embodiments of the present invention have been described in detail above referring to the drawings, but the specific configuration is not limited to the embodiments and includes, for example, an amendment to a design that falls within the scope that does not depart from the gist of the present invention.

### INDUSTRIAL APPLICABILITY

The present invention can be preferably used for a wired or radio communication system and communication apparatus.

1. A transmitting apparatus of a communication system at least including a transmitting apparatus and a receiving apparatus, the transmitting apparatus comprising:
multiple transmission data compression and coding units configured to perform, based on one or multiple pieces of header compression and coding configuration information of transmission data included in a higher layer message, compression and coding of the transmission data, wherein
first header compression and coding configuration information includes first compression and coding profile configuration for a first communication protocol header,
second header compression and coding configuration information includes second compression and coding profile configuration for a second communication protocol header,
a first transmission data compression and coding unit compresses and codes the first communication protocol header included in the transmission data, based on the first header compression and coding configuration information, and
a second transmission data compression and coding unit compresses and codes the second communication protocol header included in the transmission data, based on the second header compression and coding configuration information.

2. The transmitting apparatus according to claim 1, wherein
the first communication protocol header compressed and coded in the first transmission data compression and coding unit is a header for Ethernet (trade name) and a protocol associated with Ethernet (trade name), and the second communication protocol header compressed and coded in the second transmission data compression and coding unit is a communication protocol header other than the first communication protocol header.

3. The transmitting apparatus according to claim 1, wherein
the first header compression and coding configuration information and the second header compression and coding configuration information are applicable only to an uplink.

4. The transmitting apparatus according to claim 1, wherein
the first header compression and coding configuration information and the second header compression and coding configuration information are applicable only to a downlink.

5. A receiving apparatus of a communication system at least including a transmitting apparatus and a receiving apparatus, the receiving apparatus comprising:
multiple received data decoding and decompression units configured to perform, based on one or multiple pieces of header compression and coding configuration information of received data included in a higher layer message, decoding and decompression of the received data, wherein
first header compression and coding configuration information includes first compression and coding profile configuration for a first communication protocol header,
second header compression and coding configuration information includes second compression and coding profile configuration for a second communication protocol header,
a first received data decoding and decompression unit reconstructs the first communication protocol header by decoding and decompressing the received data, based on the first header compression and coding configuration information, and
a second received data decoding and decompression unit reconstructs the second communication protocol header by decoding and decompressing the received data, based on the second header compression and coding configuration information.

6. The receiving apparatus according to claim 5, wherein
the first communication protocol header reconstructed through decoding and decompression in the first received data decoding and decompression unit is a header for Ethernet (trade name) and a protocol associated with Ethernet (trade name), and the second communication protocol header decoded and decompressed in the second received data decoding and decompression unit is a communication protocol other than the first communication protocol header.

7. The receiving apparatus according to claim 5, wherein
the first header compression and coding configuration information and the second header compression and coding configuration information are applicable only to an uplink.

8. The receiving apparatus according to claim 5, wherein
the first header compression and coding configuration information and the second header compression and coding configuration information are applicable only to a downlink.

9. The transmitting apparatus according to claim 1, further comprising:
a feedback reception unit configured to receive a feedback PDU from the receiving apparatus, wherein
the feedback PDU includes first feedback data for the first transmission data compression and coding unit and second feedback data for the second transmission data compression and coding unit, and
the feedback reception unit separates the first feedback data and the second feedback data from the feedback PDU, transmits the first feedback data to the first transmission data compression and coding unit, and transmits the second feedback data to the second transmission data compression and coding unit.

10. The receiving apparatus according to claim 5, further comprising:
a feedback transmission unit configured to transmit a feedback PDU to the transmitting apparatus, wherein
the feedback PDU includes first feedback data from the first received data decoding and decompression unit and second feedback data from the second received data decoding and decompression unit, and
the feedback transmission unit generates a feedback PDU including the first feedback data and the second feedback data, and transmits the feedback PDU to the transmitting apparatus.
